(19) United States
(12) Patent Application Publication
(10) Pub. No.: US 2026/0233328 A1
(43) Pub. Date: Aug. 13, 2026

(54) Method for Recognizing a Replaceable Work Table or Table Type of a Laser Plotter for Cutting, Engraving, Marking, and/or Inscribing a Workpiece, as well as a Laser Plotter for Engraving, Marking, and/or Inscribing a Workpiece

(71) Applicant: Trotec Laser GmbH, Marchtrenk (AT)

(72) Inventor: Paul HAGER, Bad Wimsbach (AT)

(21) Appl. No.: 19/154,954

(22) PCT Filed: Feb. 1, 2024
(86) PCT No.: PCT/EP2024/052459

§ 371 Date: Aug. 8, 2025

(30) Foreign Application Priority Data
Feb. 9, 2023 (AT) A50079/2023

(51) Int. Cl. B23K 26/03; B23K 26/362; B23K 26/70; B23K 31/00

(52) U.S. Cl. CPC B23K 26/032; B23K 26/362; B23K 26/702; B23K 31/006

(57) ABSTRACT

A laser plotter and a method for detecting a replaceable worktable or table type of a laser plotter for cutting, engraving, marking, and/or labeling a workpiece are disclosed. At least one radiation source in the form of a laser is used within a housing of the laser plotter. When the radiation source is activated, a laser beam is directed via deflection elements to a focusing unit or laser head. A worktable or processing area is captured by at least one camera. The camera captures at least one image of the worktable and transmits it to a table analysis software. The table analysis software then evaluates one or more defined evaluation positions of the captured image of the worktable by comparing features of the worktable with stored features of possible worktables, or by reading out identification types.

### TECHNICAL FIELD

The present disclosure relates to a method for recognizing a replaceable work table or table type of a laser plotter for cutting, engraving, marking, and/or inscribing a workpiece, as well as a laser plotter for engraving, marking, and/or inscribing a workpiece.

### DESCRIPTION OF THE RELATED ART

From the state of the art, laser machines or laser plotters are already known, in which one or more laser sources are operated. For this purpose, a laser beam is sent from the laser source to a laser head or a focusing unit, where the laser beam is focused in the laser head or focusing unit via an optical element, particularly a lens. Furthermore, the laser head or focusing unit has a nozzle, where the selection of the correct nozzle influences the quality of the processing, especially the engraving, and the nozzle simultaneously protects the lens from dust or smoke. Preferably, the laser machine is connected to an external component, particularly a laptop. On the external component, particularly a computer or a control device, a graphic and/or text is created using commercial or proprietary software, such as CorelDraw, Paint, Ruby, etc., which is transferred or exported to the control unit of the laser plotter, which converts the transferred data, particularly the graphic and/or text, to control the individual elements of the laser machine or laser plotter.

Basically, systems of the applicant, particularly Trotec Laser GmbH, and also of competitors are already known, in which various settings, such as laser power, material, material thickness, lens or lens type, nozzle, etc., are set for processing the workpiece. For this purpose, the work table or table type can also be set as a parameter in the software, i.e., the user can select and set the corresponding work tables or table types under the parameter “work table or table type.” For example, a vacuum table with high suction power is necessary for optimal results in film or paper processing. When cutting acrylic, as few support points as possible are desirable to avoid back reflections. In this case, an acrylic grid table or an acrylic slat cutting table is best suited.

The work table can be easily exchanged by the user by simply lifting it from the support elements in the housing of the laser machine and inserting another work table. The user has different work tables or table types available, such as:

Aluminum grid cutting table (FIG. 2a)

Aluminum slat cutting table (FIG. 2b)

Acrylic grid cutting table (FIG. 2c)

Acrylic slat cutting table (FIG. 2d)

Vacuum table (FIG. 2e)

Ferromagnetic engraving table (FIG. 2f)

Honeycomb cutting support (FIG. 2g)

and so on,

which can be used for various tasks or processing processes.

The disadvantage here is that although a simple exchange of the work table or table type is possible with a laser device, the type of the exchanged work table or table type must be manually set in the software. This can lead to incorrect types being entered or selected in the software, or the user forgetting to adjust the work tables or table type in the software. For example, if a wrong table is used for a thick cut in acrylic, massive flame formation must be expected.

### SUMMARY OF EMBODIMENTS

An object of the present disclosure is to create a method for recognizing a replaceable work table or table type of a laser plotter for cutting, engraving, marking, and/or inscribing a workpiece, as well as a laser plotter for engraving, marking, and/or inscribing a workpiece, in which the aforementioned disadvantages are avoided and a high level of user-friendliness is achieved by recognizing the work table or table type.

The object is solved by the disclosed embodiments. Advantageous embodiments and/or procedural measures are described in the dependent claims.

The object of the present disclosure is solved by a method for recognizing a replaceable work table or table type of a laser plotter for cutting, engraving, marking, and/or inscribing a workpiece, in which at least one image of the work table or table type of the laser plotter is taken by the camera and sent to a table analysis software of a software on the laser plotter or to an externally connected component, particularly a laptop, whereupon one or more defined evaluation positions of the captured image of the work table or table type are evaluated by the table analysis software, in which features of the work table or table type are compared with stored features of the possible work tables or table types or marking types are read out. It is advantageous that the inserted table is automatically recognized. It is advantageous if the inserted work table or table type is evaluated before or during each processing process, so that the processing process is continued with the correct setting. It is also possible that a check of the set processing process with the evaluated work table or table type is carried out, so that, for example, an error message or stop of the processing process is initiated if the processing process does not match the work table. Furthermore, it is also possible to recognize a non-inserted table, so that the processing process is immediately stopped.

Measures are advantageous in which the features for recognizing the work table or table type are formed by geometric structures, holes, grids, etc., which are preferably stored in a database. This ensures that a simple comparison of the stored features with the captured features is possible.

It is advantageous to store multiple different features for different evaluation positions of the work table and use them in the table analysis software. This ensures that the work table can be recognized even when a workpiece is placed on it. If one or more evaluation positions are covered by the workpiece, there are still other evaluation positions available for the table analysis software to recognize the work table or table type.

It is advantageous if the recognition of the work table or table type is possible even when a workpiece is placed on it. This ensures that after starting the processing process, preferably before activating the laser, the table analysis software is activated and the recognition of the work table or table type is carried out. It is possible to compare the recognized work table with the set work table, so that the processing process continues if they match, and is interrupted if they do not. It is also possible to adopt the recognized work table for processing the workpiece.

It is advantageous if the table analysis software is integrated into the software of the control unit and/or the job creation or processing software, particularly the external component. This ensures easy integration.

It is advantageous if the camera is arranged in the lid of the laser plotter housing and can be triggered in both closed and open positions of the lid. This ensures that the camera, which is used to capture the position of a workpiece in the processing area, can also be used to recognize the work table or table type. Thus, a single camera can be used for both determining the position of a workpiece in the processing area of a laser plotter and recognizing the work table or table type. It is also possible to arrange a separate camera for recognizing the work table or table type. It is advantageous to use a camera arranged in the lid for capturing the workpiece and recognizing the work table or table type.

It is advantageous if the recognized work table or table type is compared with the set work table or table type in the control unit or software, or if the recognized work table or table type is adopted by the control unit or software. This ensures that a change of the work table or table type is automatically recognized. If the used work table or table type does not match the set work table or table type, the user is notified, for example, by opening a window on the connected component, particularly a laptop, that the used work table or table type does not match the set work table or table type. It is also queried whether the newly used or recognized work table or table type should be adopted. If the stored work table or table type matches the queried work table or table type, the processing process can be started. It is possible to automatically query or check the work table or table type after activating the processing process.

It is advantageous if a reference image or image of the work table or table type is captured by the camera and stored in a database. This ensures a simple and quick comparison of a captured image with the reference image.

It is advantageous if one or more positions for evaluating the work table or table type are defined on the reference image or image, and a newly captured image is evaluated at these positions. This ensures a quick evaluation, as the areas to be evaluated are stored in the reference image. By using multiple positions, it is also possible to recognize the work table when a workpiece is placed on it, even if one or more positions are covered by the workpiece. If the workpiece covers the entire work table, this is recognized by the table analysis software and a corresponding notice or warning is issued, allowing the user to address it.

It is advantageous if the recognized work table or table type is compared with the work tables or table types stored in the software. This ensures that deviations are automatically detected.

It is advantageous if the recognition of the work table or table type is carried out at the start of a job or processing process. This ensures that the used work table or table type is checked when a job is called without a connected external component.

It is advantageous if the recognized work table or table type, particularly the captured images, are stored on a storage medium, particularly in a cloud. This ensures easy access for remote maintenance. Additionally, data can be collected for warranty processing.

It is advantageous if the recognition of the work table or table type is carried out using deep learning. This ensures that a large number of images can be processed.

It is also advantageous if a laser beam emitted by the radiation source is sent to at least one focusing unit via deflection elements to process the workpiece, where the laser beam is deflected towards the workpiece and focused for processing, with control carried out by software running in a control unit, preferably by executing a job, particularly from transferred or loaded data, with the workpiece processed by moving a carriage in the X-Y direction, preferably via a belt drive, with a graphic and/or text created on an external component, particularly a computer or control device, using commercial or proprietary software, such as CorelDraw, Paint, Ruby, etc., which is transferred or exported to the control unit of the laser plotter, converting the transferred data, particularly the graphic and/or text, to control the individual elements of the laser machine or laser plotter. This ensures that after recognizing the work table or table type, the workpiece can be processed. It is possible to automatically query the work table or table type at the start of a processing process or manually query the work table or table type and then start the processing process.

The object of the present disclosure is also solved by a laser plotter for engraving, marking, and/or inscribing a workpiece, where a table analysis software is used to evaluate the inserted work table or table type. It is advantageous that the recognition of the inserted work table or table type is automatically carried out. After recognizing the work table or table type, it is compared with the work tables or table types stored in the software, and a notice is displayed in case of deviation. It is also possible to automatically adopt the queried work table or table type into the software.

It is advantageous if the table analysis software is designed to evaluate optical features, particularly geometric structures, holes, grids, etc. This ensures that the used work table or table type can be evaluated by simply capturing an image.

The disclosure is described in the form of an exemplary embodiment, noting that the disclosed embodiments are not limited to the depicted and described embodiment or solution but can be applied to equivalent solutions.

### BRIEF DESCRIPTION OF THE DRAWINGS

The Figures show:

FIG. 1: A schematic representation of a laser machine, particularly a laser plotter, for processing a workpiece with a camera system on the lid, in a simplified, schematic representation.

FIG. 2A: A schematic representation of the laser machine, particularly the laser plotter, with an aluminum grid cutting table, in a simplified, schematic representation.

FIG. 2B: A schematic representation of the laser machine, particularly the laser plotter, with an aluminum slat cutting table, in a simplified, schematic representation.

FIG. 2C: A schematic representation of the laser machine, particularly the laser plotter, with an acrylic grid cutting table, in a simplified, schematic representation.

FIG. 2D: A schematic representation of the laser machine, particularly the laser plotter, with an acrylic slat cutting table, in a simplified, schematic representation.

FIG. 2D: A schematic representation of the laser machine, particularly the laser plotter, with a vacuum table, in a simplified, schematic representation.

FIG. 2F: A schematic representation of the laser machine, particularly the laser plotter, with a ferromagnetic engraving table, in a simplified, schematic representation.

FIG. 2G: A schematic representation of the laser machine, particularly the laser plotter, with a honeycomb cutting support, in a simplified, schematic representation.

FIG. 3: An image taken by a camera arranged in the lid of the laser machine, showing the processing area without an inserted processing table, in a simplified, schematic representation.

FIG. 4: A schematic representation of a software interface on the screen of the external component, in a simplified, schematic representation.

FIG. 5: A schematic representation of a laser machine with an image taken for table recognition, in a simplified, schematic representation.

FIG. 6: Another embodiment of a schematic representation of a laser machine with an image taken for table recognition, in a simplified, schematic representation.

It should be noted that in the different embodiments, identical parts are provided with identical reference signs or identical component designations, whereby the disclosures contained in the entire description can be transferred analogously to identical parts with identical reference signs or identical component designations. The positional indications chosen in the description, such as top, bottom, side, etc., refer to the described figure and should be transferred analogously to the new position in case of a change in position.

### DETAILED DESCRIPTION OF EMBODIMENTS

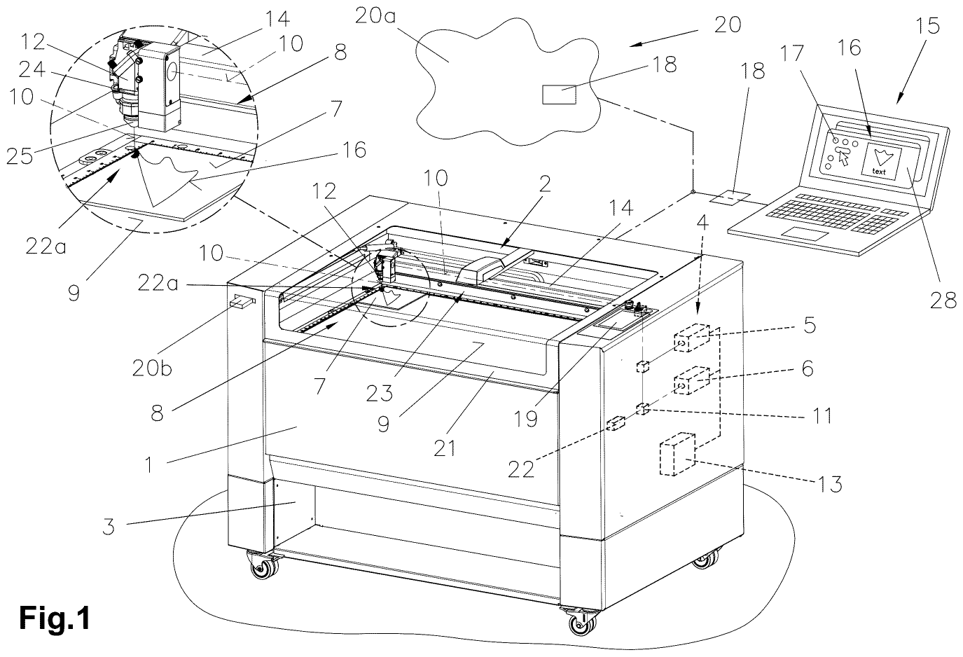

In FIGS. 1 to 6, embodiments of laser machines 1 or laser devices 1, particularly laser plotters 1, are shown, in which a camera system 2 is integrated.

In the shown laser plotter 1, at least one, preferably two, radiation sources 4 or laser sources 4 in the form of lasers 5, 6 are arranged in a housing 3. The lasers 5 and 6 preferably act alternately on a workpiece 7 to be processed. The workpiece 7 is or will be positioned in a processing area 8 of the laser plotter 1, particularly on a processing table 9, which is preferably height-adjustable. A laser beam 10 emitted by a radiation source 4, particularly the laser 5 or 6, is sent via deflection elements 11 to at least one movable focusing unit 12 or a movable laser head 12, from which the laser beam 10 is deflected towards the workpiece 7 and preferably focused for processing via a lens in the focusing unit 12 or in the laser head 12. The control, particularly the position control of the laser beam 10 to the workpiece 7, is carried out by software running in a control unit 13, whereby the workpiece 7 is processed by moving a carriage 14, on which the focusing unit 12 or the laser head 12 is also movably arranged, preferably via a belt drive in the X-Y direction. Here, it is possible that, for example, in the processing process “engraving,” the carriage 14 is moved line by line, whereas in the processing process “cutting,” the carriage 14 is moved according to the contour to be cut, i.e., not line by line.

On an external component 15, particularly a computer, laptop, or control device, a graphic 16 and/or text 16 is created or loaded using commercial software 17, such as CorelDraw, Paint, etc., or using proprietary application software 17, particularly Ruby 17, which is exported or transferred to the control unit 13 of the laser machine or laser plotter 1 in the form of a job 18. Preferably, the data to be transferred is converted by the same or another software so that the control unit 13 can process the job 18. Of course, it is also possible for the input to be made directly on the laser plotter 1 using the existing input means 19, such as a touchscreen 19 or input keys, or for a corresponding job 18 to be loaded from a storage medium 20, such as a cloud 20a, a USB stick 20b, etc. After the data, particularly the job or jobs 18, has been transferred or created directly or loaded from the storage medium 20, the job 18 is processed by the laser machine or laser plotter 1, particularly its control unit 13. It is possible for multiple jobs 18 to be stored and processed sequentially in the laser machine 1, particularly the laser plotter 1.

In such laser machines 1, particularly laser plotters 1, it is necessary for safety that to start a job 18, in which the laser beam 10 acts on the workpiece 7, a lid 21 or door 21, which is preferably at least partially transparent, must be closed, as shown in FIG. 1.

Subsequently, the operating personnel can manually or automatically position the laser point or a laser pointer 22, particularly the laser pointer point 22a, which is coupled into the beam path of the lasers 5, 6 and deflected towards the processing table 8 via the focusing unit 12 or laser head 12, on the inserted workpiece 7, after which the job 18 for processing the workpiece 7 can be started. At the end of the job 18, the carriage 14 and the focusing unit 12 or laser head 12 are preferably moved back to the starting position so that the finished workpiece 7 can be removed, after which a new processing process can be started by inserting a new workpiece 7 or a blank 7. It is advantageous if the end of the processing is indicated visually or acoustically so that the user does not have to constantly monitor the laser machine 1, particularly the laser plotter 1. For completeness, it is mentioned that the adjustment of the focusing unit 12 or the laser head 12 with the activated laser pointer 22 is also possible with the lid 21 open, but the laser 5, 6 cannot be activated.

Furthermore, at least one camera 23 is provided in the camera system 2, with the camera 23 being located in the lid 21, particularly centrally in the middle of the lid 21. The camera 23 is intended to capture the processing area 8, particularly the processing table 9, so that an inserted workpiece 7 can be recognized on the processing table 9. To ensure that a larger processing area 8 can be covered with one camera 23, the camera 23 used preferably has a fisheye lens, and a calibration to correct the captured processing area 8 must be carried out during the initial use of the camera 23. However, it is also possible to arrange two or more cameras 23 in the lid 21 to capture the entire processing table 9, with fisheye lenses or normal lenses preferably being used. Of course, another positioning of the camera 23, for example, on the side walls of the processing area 8, i.e., not on the lid 21, is also possible. The camera 23 is used, for example, to capture the position of the inserted workpiece 7 and preferably displayed on the external component 15, particularly the laptop. The position of the workpiece 7 is preferably captured before processing or starting the processing process so that the focusing unit 12 or the laser head 12 can be positioned accordingly via the laser pointer 22, for example, at the start of the processing process or for determining the height of the processing table 9. For completeness, it is noted that the position of the workpiece 7 can also be recognized with the lid 21 open, i.e., an image of the processing table 9 or the processing area 8 can be captured with the lid 21 open.

In the novel laser plotter 1 or the novel laser machine 1, it is now provided that the laser machine 1 or the laser plotter I performs a method for recognizing a replaceable processing table 9 or table type 9 of a laser plotter 1 for cutting, engraving, marking, and/or inscribing a workpiece 7, or the laser plotter 1 is designed for this purpose.

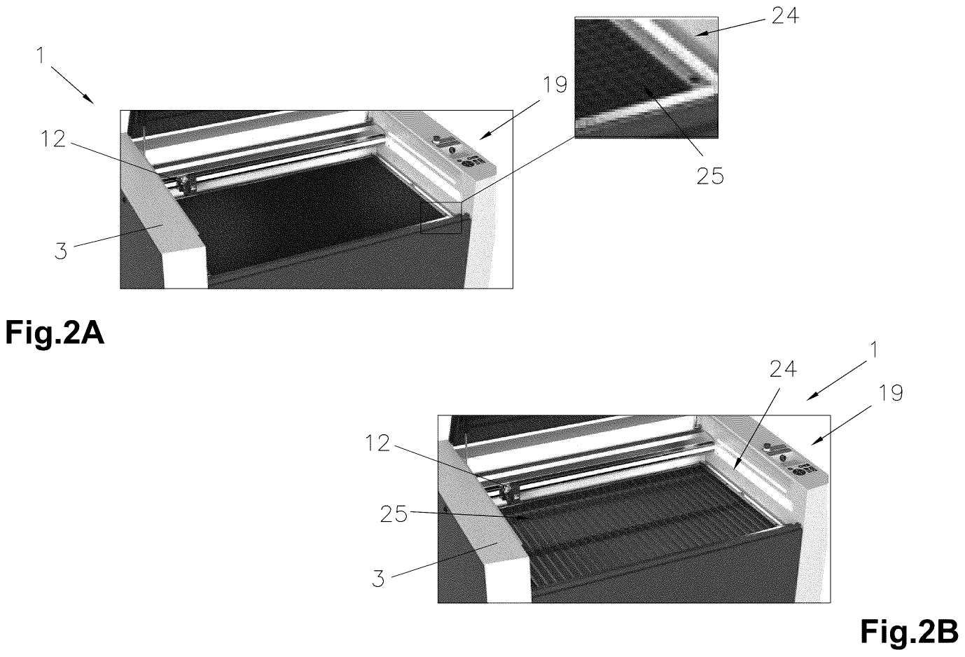

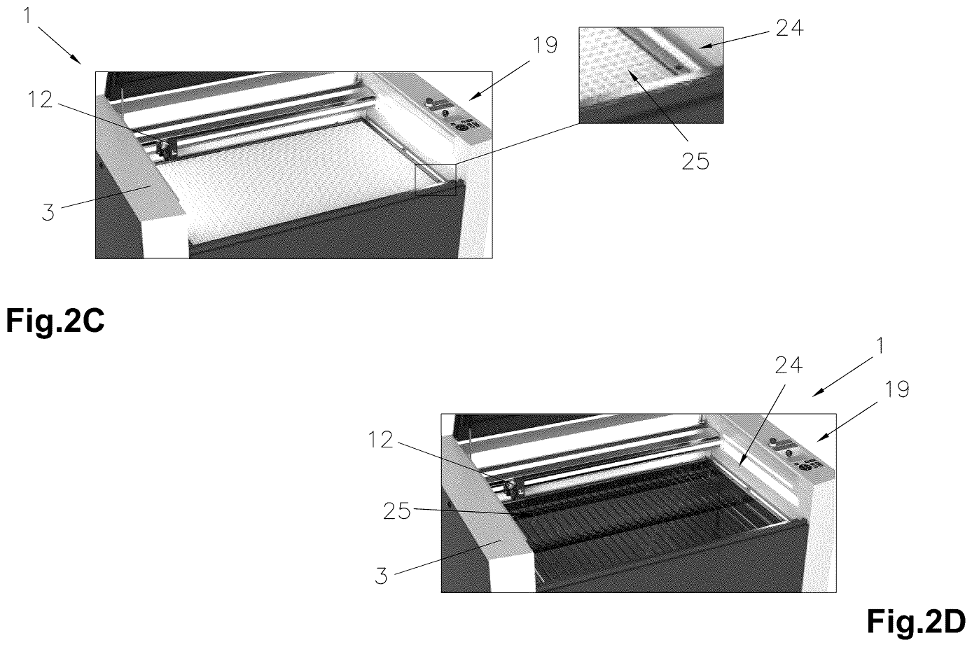

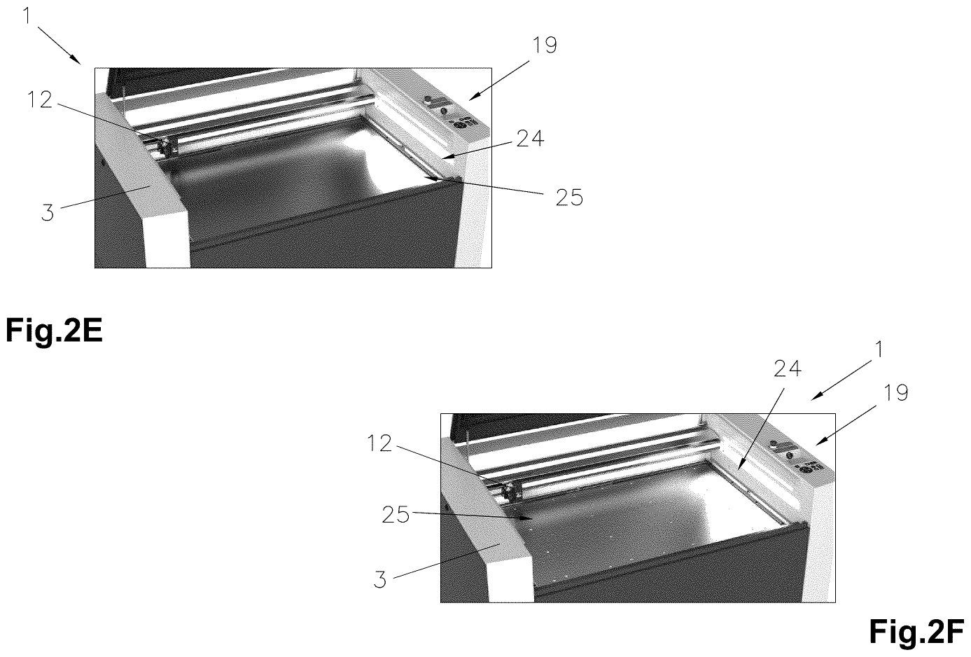

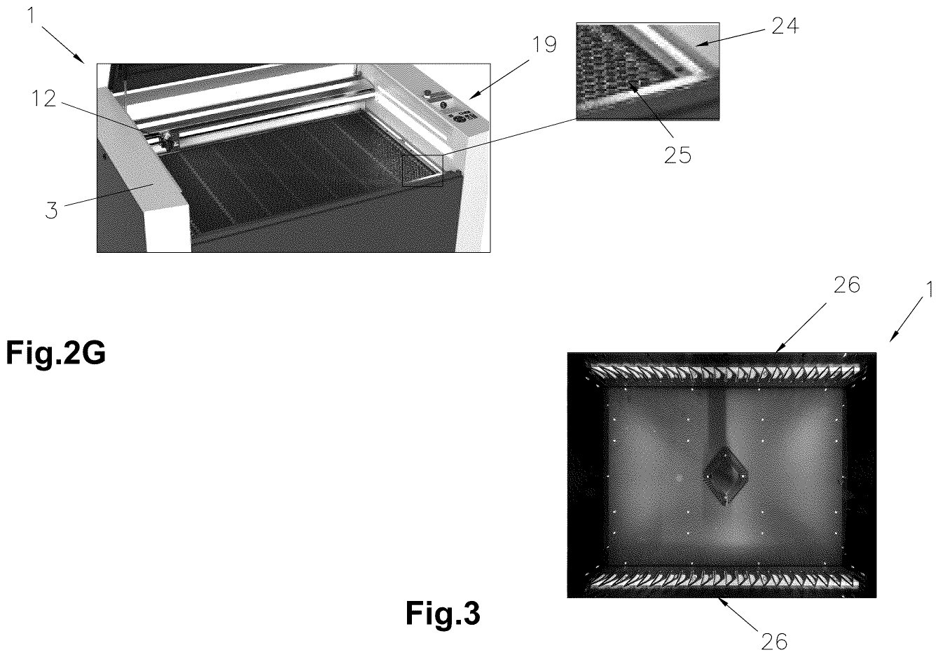

For this purpose, FIGS. 2A to 2G show embodiments of different processing tables 9 or table types 9. The robust aluminum grid cutting table, particularly the universal cutting table, according to FIG. 2A, offers a lot of stability and is particularly suitable for cutting tasks with parts smaller than 100 mm, as these remain flat in position after cutting. The processing table 9 has more support points compared to the aluminum slat cutting table. The aluminum slat cutting table, according to FIG. 2B, is particularly suitable for cutting thicker materials (from 8 mm thickness) and for parts that are cut wider than 100 mm. The slats can be individually inserted, allowing the table to be adapted to any application. The acrylic cutting grid, according to FIG. 2C, prevents back reflections when cutting and is therefore particularly suitable for cutting acrylic, laminates, and plastic films. It is ideal for parts smaller than 100 mm, as these remain flat in position after cutting. The acrylic slat cutting table, according to FIG. 2D, prevents back reflections when cutting and is therefore particularly suitable for cutting thicker acrylic sheets (from 8 mm thickness) and for parts that are cut larger than 100 mm. The slats can be individually positioned and adapted to any application. The vacuum table, according to FIG. 2E, fixes the material to the processing table by means of a vacuum. This ensures proper focusing over the entire surface and even better engraving results. Furthermore, the handling effort is reduced as manual fixing is not necessary. The vacuum table is the ideal table for thin and light materials, such as paper and films, which tend not to lie completely flat on the surface. The ferromagnetic engraving table, according to FIG. 2F, allows thin materials, such as paper or films, to be easily fixed with magnets. A flat processing surface is a crucial criterion for optimal results in laser engraving or laser marking. The honeycomb cutting support, according to FIG. 2G, is particularly suitable for applications that require back reflections and the best flatness, such as cutting membrane keyboards. It is also possible to use the honeycomb cutting support in combination with the vacuum table, i.e., to combine different table types 9. Of course, other processing tables 9 or table types 9 can also be used that are not shown and listed.

Typically, the processing tables 9 or table types 9 are constructed in such a way that they have a surrounding edge strip 24, within which the different support types 25, such as slats, grids, honeycombs, etc., are arranged or formed. The edge strip 24 or the processing table 9 is placed or fixed on preferably height-adjustable support elements 26 in the processing area 8, with the support elements 26 being arranged on at least two opposite side lengths of the processing area 8, as can be seen from FIG. 3.

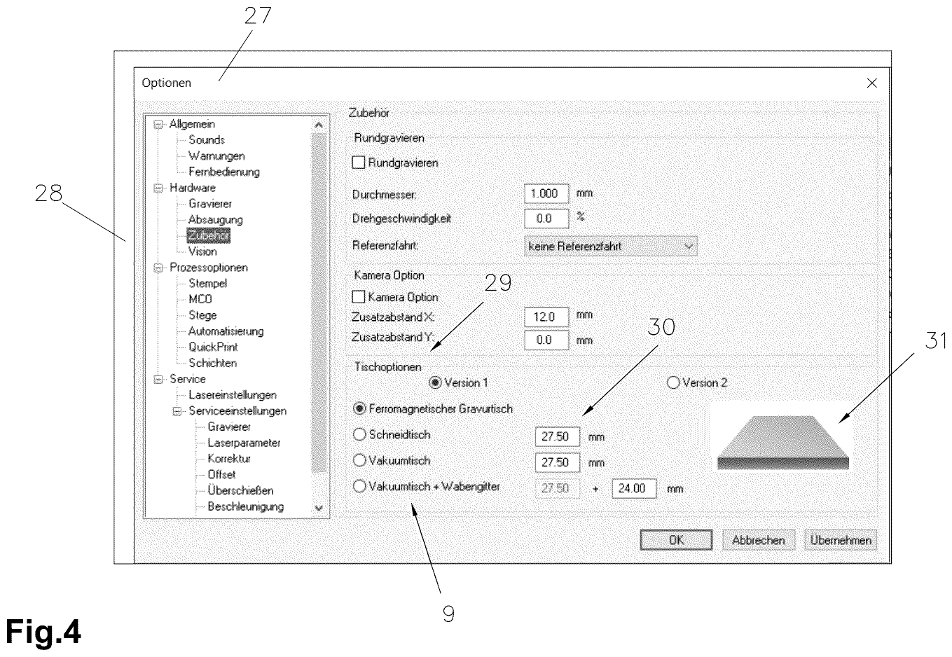

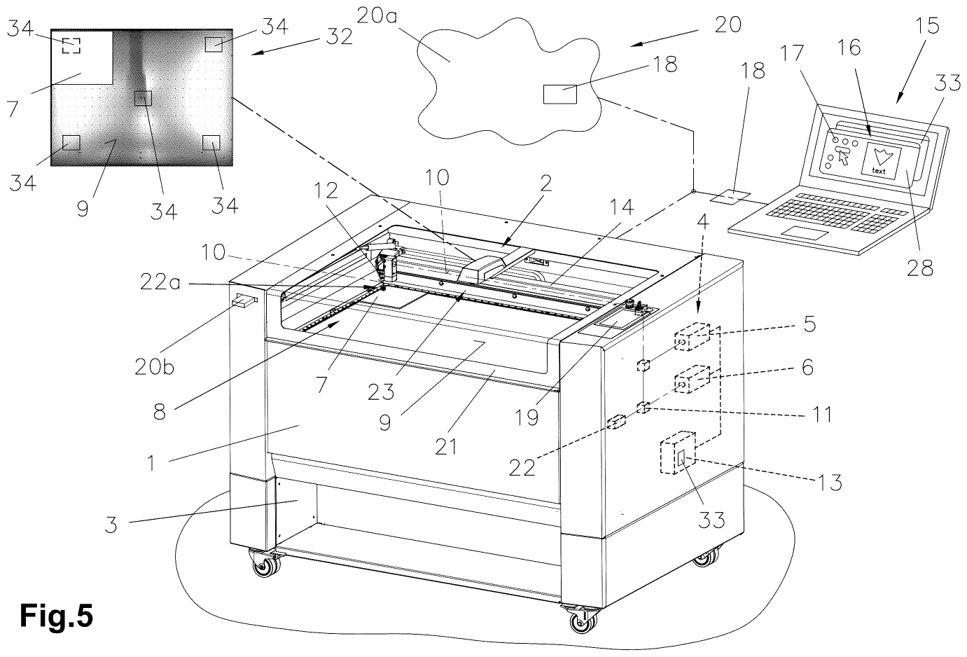

As known from the state of the art, the table type 9 or the processing table 9 is manually selected and set by the user in the software or application software, as shown in FIG. 4. For this purpose, an options window 27 of a software 28, particularly an application software 28 of the applicant, is shown in FIG. 4, where under the menu item “Table options 29,” the possible table types 9 or processing tables 9 for this laser plotter 1 under version 1, such as a ferromagnetic engraving table, vacuum table, vacuum table +honeycomb grid, can be selected by clicking with the mouse. It is possible to enter additional information 30 about the displayed and selectable table types 9. Additionally, a schematic table image 31 of the selected table type 9 is also displayed in this table option 29. For completeness, it is noted that the user can also select a second version 2, under which a different selection of table types 9 is possible or that all table types 9 are selectable. By manually setting the table type 9, the user may make errors in selecting the table type 9 or processing table 9, or the user may forget or ignore setting the processing table 9.

To avoid this, it is provided according to some embodiments that an automatic table recognition of the processing table 9 or the table type 9 is provided in the laser machine 1, particularly in the laser plotter 1. The table recognition can be manually started or automatically executed before each processing process. For this purpose, at least one image 32 of the processing table 9 or the table type 9 of the laser plotter 1 is taken by a camera 23 and sent to a table analysis software 33 of a software 28 on the laser plotter 1 or to an externally connected component 15, particularly a laptop 15, whereupon one or more defined evaluation positions 34 of the captured image 32 of the processing table 9 or table type 9 are evaluated by the table analysis software 33, in which features of the processing table 9 or table type 9 are compared with stored features of the possible processing tables 9 or table types 9.

It is possible that the table recognition or the table analysis software 33 can be carried out with an inserted workpiece 7, as shown schematically in FIG. 5, although table recognition without an inserted workpiece 7 is also possible. For this purpose, the image 32 is taken with the workpiece 7 inserted on the processing table 9. Subsequently, the table analysis software 33, which runs in its own software window or in the background in the control unit 13 or the external component 15, defines and queries at least one evaluation position 34. If the evaluation position 34 is covered by the workpiece 7, as shown in FIG. 5, this is recognized due to the capture of the image 32, so that at least one further evaluation position 34 is defined and queried in another area of the captured image 32. Subsequently, the features for recognizing the processing table 9 or table type 9 are loaded. The features are preferably formed by geometric structures, holes, grids, etc., which are preferably stored in a database, so that they can be queried or loaded by the table analysis software 33. Preferably, different images of the features of the various processing tables 9 or table types 9 are stored and can be queried for the different evaluation points 34, to enable a simple comparison of the stored features with the captured image 32 or image features. Here, the table analysis software 33 can, for example, enlarge the captured evaluation positions 34 of the image 32 to better analyze the details of the used processing table 9. It is also possible that multiple different features for different evaluation positions 34 of the processing table 9 or processing tables 9 are stored and can be used by the table analysis software 33. It is advantageous if images of the various processing tables 9 are stored for the different evaluation positions 34 as features, so that the used or inserted processing table 9 can be recognized by simple comparison by the table analysis software 33.

If a table recognition has been successfully carried out, it is possible that the recognized processing table 9 or table type 9 is compared with the processing table 9 set in the software 28 or that the recognized processing table 9 is displayed on the software 28 or on the screen of the external component and/or on the input means 19 of the laser plotter 1, so that it can be adopted or not adopted by the user, for example, by selecting a button. If there is a deviation between the selected processing table 9 and the recognized processing table 9, a corresponding notice is displayed by the software 28, so that the user must then take appropriate measures, such as adopting or rejecting the recognized processing table 9. It is also possible that the recognized processing table 9 or table type 9 can be directly adopted into the software 28.

Furthermore, it is also possible that the table analysis software 33 or the software 28 can execute additional functions that can be activated in the software 28 or automatically carried out. For example, the function “Consider parameters” can be selected or carried out by default, in which certain settings or parameters for the processing process are assigned to the processing tables 9 or table types 9. Based on the set parameters, particularly the material type, material thickness, processing type, such as cutting, engraving, marking, etc., the table analysis software 33 checks whether the user has inserted and/or selected a matching processing table 9 or table type 9, i.e., the table analysis software 33 checks after recognizing the processing table 9 or table type 9 whether the inserted processing table 9 is possible or permissible for the intended processing process with the set parameters. This can also be used by default. For this purpose, one or more parameters are assigned to the individual processing tables 9 or table types 9 in the software 28, particularly in the table analysis software 33. It is possible that multiple different processing tables 9 or table types 9 can be assigned to the set parameters, so that if a recognized processing table 9 matches the possible processing tables 9, this recognized processing table 9 is adopted or the user must manually agree to this. It is advantageous in assigning the processing tables 9 or table types 9 to certain settings or parameters that this prevents a processing process from being started by selecting a processing table 9 in the software 28 and matching the recognized processing table 9, which is not suitable due to the set parameters or settings, i.e., the user has selected and set a processing table 9 in the software 28, and this processing table 9 has also been inserted by the user into the processing area 8, particularly on the support elements 26, but the table analysis software 33 recognizes the selected processing table 9 as not suitable for the set processing process due to the settings or parameters, so that a corresponding warning is issued and the processing process is not started. In other words, set parameters, such as material selection, material thickness, etc., are assigned or stored to various table types 9 or processing tables 9, so that it can also be checked whether the used processing table 9 or table type 9 is suitable for the set parameters or not. Preferably, a table recognition is carried out before each processing process.

However, it is also possible to manually start the table recognition, for which a button is preferably provided in the software 28. Here, the manual table recognition is also possible with the lid 21 open and closed.

It is also possible that the recognized processing table 9 or table type 9, particularly the captured image 32, is additionally stored on a storage medium 20, particularly in a cloud 20a. Preferably, the settings or parameters and criteria under which a job 18 is processed are also stored, particularly in an external component 15 and/or cloud 20a, so that sources of errors or disturbances can be analyzed later. For example, it can also be checked via remote maintenance whether original processing tables 9 or table types 9 are used. This is particularly important for disturbance analysis and can also provide essential information for handling warranty and guarantee cases. In general, it is advantageous if captured images 32 from the camera 23 are preferably stored with the set parameters in a database. The database is preferably stored on the component 15 and/or another external storage medium 20, particularly the cloud 20a, and preferably also designed or set up for remote access, e.g., by a remote maintenance team. The database can also be stored or arranged internally in the software of the control unit 13.

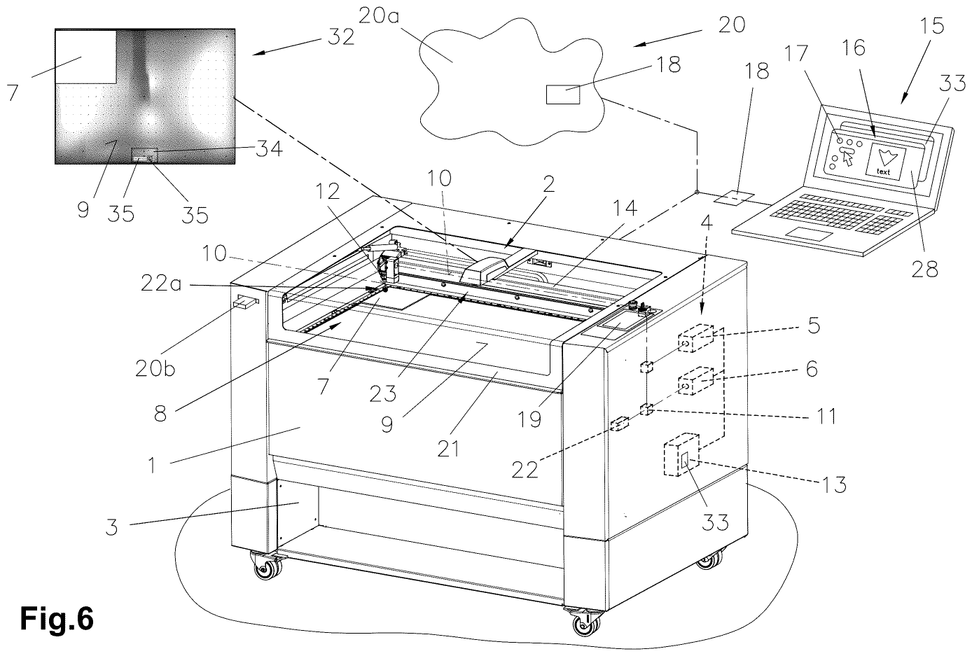

FIG. 6 shows another possibility of table recognition, in which one or more evaluation positions 34 are again defined in the captured image 32, but now the table analysis software 33 no longer compares features of the table surface or table structure, but queries the evaluation position 34 for marking types 35, particularly a marking or 2D code, particularly data matrix code, or code, particularly QR code. In the illustrated embodiment, a printed or applied marking “Vacuum table” and a code, particularly QR code, are shown in the evaluation position 34, although only one or more marking types may be present. Preferably, such marking types are arranged on the edge of the processing table 9 or table type 9. Multiple marking types 35 can also be applied to a processing table 9. It is also possible that when using a code, particularly QR code, the table analysis software 33 directly reads the code. Here, table recognition is also possible with or without an inserted workpiece 7. It is advantageous if a 2D code, particularly a data matrix code, is positioned near the ruler, i.e., in the edge area of the processing table 9.

Furthermore, the recognition of the processing table 9 or the table type 9 can be carried out using deep learning. In deep learning, a neural network is trained with a series of tables or table types 9. The trained network can then be located locally, i.e., on the laser plotter 1 or on the connected component 15, or in the cloud 20a. Deep learning is used to recognize images 32.

It is also possible to recognize whether no processing table 9 or table type 9 has been inserted, so that processing is prevented, i.e., that by capturing the image 32 of the processing area 8, the table analysis software 33 recognizes that no processing table 9 or table type 9 has been placed on the support elements 26, so that the start of a processing process is prevented.

By recognizing the processing table 9 using a captured image 32, it is also possible to detect modifications to the table or processing table 9. If a modification of a processing table 9 is detected, the processing of a workpiece 7 can be prevented, or the customer is informed and must manually approve or start the processing process.

It is advantageous if the camera 23, which is used to capture the workpiece 7, is also used to capture the image 32 of the processing table 9 or table type 9, i.e., that with one camera 23, which is preferably arranged in the lid 21, the capture of the workpiece 7 and the recognition of the processing table 9 or table type 9 is carried out. One can say that the camera 23 used for capturing the position of an inserted workpiece 7 in the processing area 8, particularly on the processing table 9, is also used for recognizing the processing table 9 or table type 9, particularly for capturing the image 32 of the processing table 9 or table type 9. The capture of the workpiece and the recognition of the processing table can be carried out in one operation or sequentially.

For the sake of order, it is pointed out that the present disclosure is not limited to the illustrated embodiments but can also include further designs and constructions.

1. A for detecting an interchangeable worktable of a laser plotter for cutting, engraving, marking, and/or labeling a workpiece, wherein at least one radiation source in a form of a laser is used in a housing of the laser plotter, and when the at least one radiation source is activated, a laser beam is directed via deflection elements to a focusing unit, and the worktable is captured by at least one camera wherein the at least one camera captures at least one image of the worktable of the laser plotter and sends it to a table analysis software of a software on the laser plotter, whereupon one or more defined evaluation positions of the captured image of the worktable are evaluated by the table analysis software, in which features of the worktable are compared with stored features of possible worktables, or types of markings are read out.

2. The method according to claim 1, wherein the features of the worktable are formed by geometric structures, holes, or grids.

3. The method according to claim 1, wherein several different features for different evaluation positions of the worktable are stored and used by the table analysis software.

4. The method according to claim 1, wherein the evaluation of the worktable also takes place or is possible with an inserted or placed workpiece.

5. The method according to claim 1, wherein the table analysis software is formed by software that is integrated into the software of a control unit (13) and/or in the software for job creation or processing software in an external component.

6. The method according to claim 1, wherein the at least one camera is arranged in a lid of the housing of the laser plotter and can be triggered both in a closed and open position of the lid.

7. The method according to claim 1, wherein the worktable is compared with a worktable set in the a control unit, or that the worktable is adopted by the control unit.

8. The method according to claim 1, wherein a reference image of the worktable is captured by the at least one camera and stored in a database.

9. The me according to claim 8, wherein one or more positions for evaluating the worktable are defined on the reference image, and a newly captured image is evaluated at positions.

10. The method according to claim 1, wherein, after evaluation of the worktable, the worktable is compared with worktables stored in the software.

11. The method according to claim 1, wherein the evaluation of the worktable is carried out at a start of a job for processing process.

12. The method & according to claim 1, wherein the captured at least one image of the worktable is stored on a storage medium.

13. The method according to claim 1, wherein the evaluation of the worktable is carried out using deep learning.

14. The method according to claim 1, wherein, to process the workpiece, a laser beam emitted by the radiation source is sent via deflection elements to at least one focusing unit, from which the laser beam is deflected in the direction of the workpiece and focused for processing, wherein control is carried out by software running in a control unit by executing a so-called job, wherein the workpiece is processed by adjusting a carriage via a belt drive in the X-Y direction, wherein on an external component, a graphic and/or a text is created via standard software, which is transferred to the control unit of the laser plotter which performs a conversion of the transferred data to control the individual elements of the laser plotter.

15. A laser plotter for engraving, marking, and/or labeling a workpiece, which has a working area for positioning the workpiece, at least one; radiation source in a form of a laser with corresponding deflection elements, and a control unit for controlling a carriage operated via a belt drive with a focusing unit arranged movably thereon, wherein a camera is arranged for image capture of the working area, wherein, for capturing an image of an inserted worktable, the camera is brought or positioned into a defined position, wherein a table analysis software is designed to evaluate the inserted worktable.

16. The laser plotter according to claim 15, wherein the table analysis software is designed to evaluate optical features.

17. The laser plotter according to claim 15, wherein the laser plotter is designed to apply or execute a method for evaluating one or more defined evaluation positions of the captured image of the inserted worktable, in which features of the inserted worktable are compared with stored features of possible worktable.
